(19) United States
(12) Patent Application Publication
(10) Pub. No.: US 2003/0078809 A1
(43) Pub. Date: Apr. 24, 2003

(54) Prescription approval system and method

(76) Inventor: Jude LaCour, Ormond Beach, FL (US)

Correspondence Address: Mark L. Lorbiecki, Esq., BLACK LOWE & GRAHAM PLLC, 816 Second Avenue, Seattle, WA, 98104, US

(21) Appl. No.: 10/032,909

(22) Filed: Oct. 18, 2001

(51) Int. Cl. G06F 17/60

(52) U.S. Cl. 705/3

(57) ABSTRACT

A network-based system and method for reviewing and approving or declining orders, particularly for prescription drugs includes a server and an associated memory accessible over the network. Doctors access the server to review customer order requests and medical histories. If the prescription is warranted based on the customer medical condition, the doctor approves the order for further processing and delivery.

### FIELD OF THE INVENTION

This invention relates generally to remote prescription approval and fulfillment and, more specifically, to systems and methods for obtaining physician approval of requests for drug prescriptions.

### BACKGROUND OF THE INVENTION

The Internet has provided a medium for many new businesses to meet customer demands quickly and efficiently while reducing overhead and start-up costs. To take advantage of these benefits, many pharmaceutical companies have developed Web sites that sell various drugs to consumers. Likewise, established drug store chains have embraced the Internet as a valuable distribution channel for their drugs and other products.

Many of the medications that such electronic pharmacies offer are sometimes called “embarrassment” drugs because they are intended to treat embarrassing conditions. For example, many consumers are self-conscious when purchasing drugs to treat erectile dysfunction, hair loss, weight loss, herpes, and other potentially embarrassing maladies. The ability to purchase such drugs electronically allows them to be obtained relatively anonymously, without any embarrassment.

The computer-based ordering system works particularly well for over-the-counter drugs and other products that do not require a prescription. Consumers are able to select and purchase those products over the Internet just as they would form a “brick and mortar” store, except that they can more easily compare prices and enjoy the convenience of shopping from home at any time, day or night.

Prescription drugs, on the other hand, have presented a thorny problem for drug providers. Some drugs require physical examinations of various degrees in order to issue a prescription. Thus, in some cases an actual face-to-face examination must occur, while in other cases a more general medical history review is sufficient. Some on-line pharmacies have either ignored these requirements or have difficulty following them, and have been under fire for issuing drugs without a prescription. Even those pharmacies that have intended to dispense prescription drugs only with a prescription have sometimes found it difficult to process the order in a manner that is efficient while verifying the request is accompanied with a prescription.

Accordingly, there is a need for a system and method that facilitates the approval and delivery of drugs and other products with the proper authorization, and overcomes some of the above problems.

### SUMMARY OF THE INVENTION

The present invention comprises a system for processing drug orders while ensuring that all orders requiring a prescription are accompanied by a prescription.

In accordance with further aspects of the invention, a server is coupled to a network which is preferably the Internet. The server includes an associated memory and stored programming instructions, which preferably comprise Web pages.

In accordance with other aspects of the invention, any number of client computers connected to the network can access the server. The server causes web pages to be presented on the client displays to allow clients to order drugs or other products.

In accordance with still further aspects of the invention, doctors or other professionals can also access the server via a client computer. Doctors are presented with one or more patient request requiring a prescription based on a review of a patient medical history. Depending on the information contained in the medical history, a doctor either approves or declines the requested prescription.

In accordance with yet other aspects of the invention, security measures are included such as a doctor login screen requiring entry and validation of a doctor password.

In accordance with still another aspect of the invention, prescriptions requests can be submitted by patients, doctors, medical professionals or others.

In accordance with still further aspects of the invention, patient medical histories or physical examination data can be entered and reviewed by separate doctors or entered by the doctor performing the examination.

Accordingly, a doctor can review requested prescriptions and approve or decline them based upon an appropriate medical history review.

### BRIEF DESCRIPTION OF THE DRAWINGS

The preferred and alternative embodiments of the present invention are described in detail below with reference to the following drawings.

FIG. 1 is a block diagram of a preferred prescription authorization system of the present invention;

FIG. 2 is a flow diagram of a preferred prescription authorization method of the present invention;

FIG. 3 is a screen display of a doctor login process in accordance with the present invention;

FIG. 4 is a screen display of a main menu in accordance with the present invention;

FIG. 5 is a screen display of an order retrieval process in accordance with the present invention;

FIG. 6 is a screen display of an order accounting listing in accordance with the present invention; and

FIG. 7 is a preferred doctor general consultation form in accordance with the present invention.

### DETAILED DESCRIPTION OF THE PREFERRED EMBODIMENT

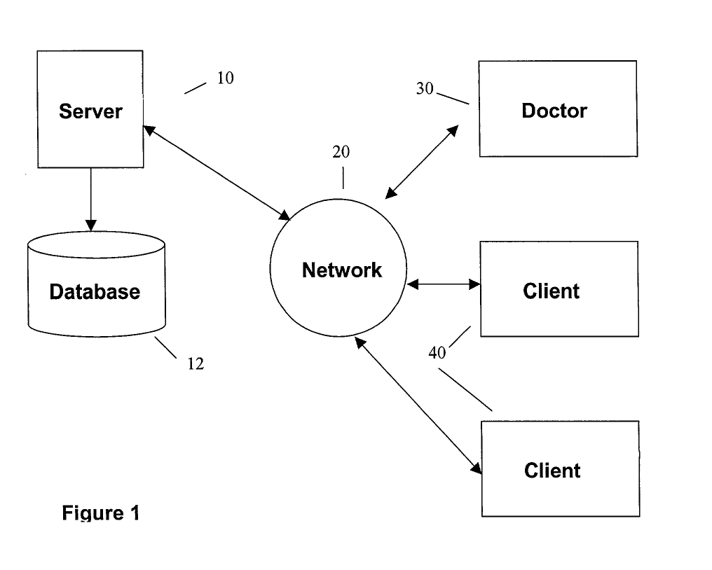

A preferred prescription approval system is illustrated in FIG. 1. The system includes a server 10 and associated memory 12 accessible over a network 20. The server can comprise any computer-based system, and is preferably configured to operate, or host, one or more Web pages accessible over a network. Accordingly, the network 20 is preferably the Internet, although it could alternatively be any wired or wireless communication channel.

A plurality of clients 40 are also coupled to the network 20. The clients 40 are preferably desktop or laptop computers having a processor, display, memory, input/output devices, and other typical components. Alternatively, the clients 40 may comprise any wired or wireless microprocessor-based device such as a personal digital assistant, pager, cellular telephone, or other devices adapted to communicate over the network 20. Accordingly, the clients 40 are able to communicate with the server 10 over the network 20.

Although two are illustrated in FIG. 1, any number of clients 40 may be present in accordance with the present invention. Likewise, the clients 40 may serve a wide array of end-users. For example, clients 40 may be patients seeking prescriptions, nurses or other professionals requesting prescriptions, or administrative personnel seeking information or making changes to the system. Doctors reviewing prescriptions for approval also access the server 10 via a client machine, and for that reason the system is illustrated as including a doctor 30 in communication over the network 20. Preferably, the doctor 40 accesses the server 10 using a machine that is essentially the same as other clients 30.

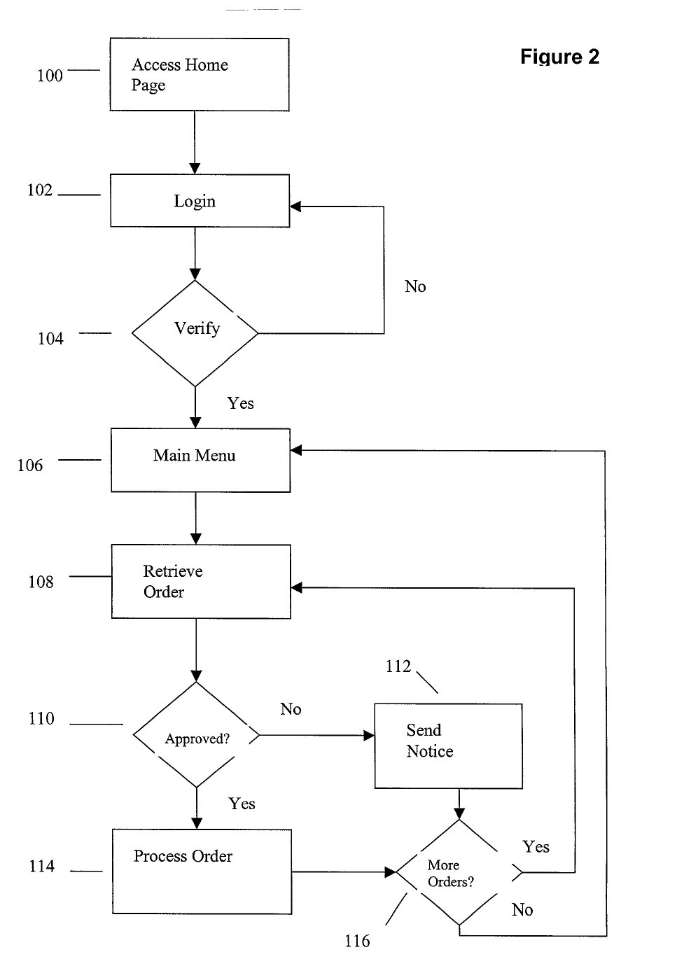

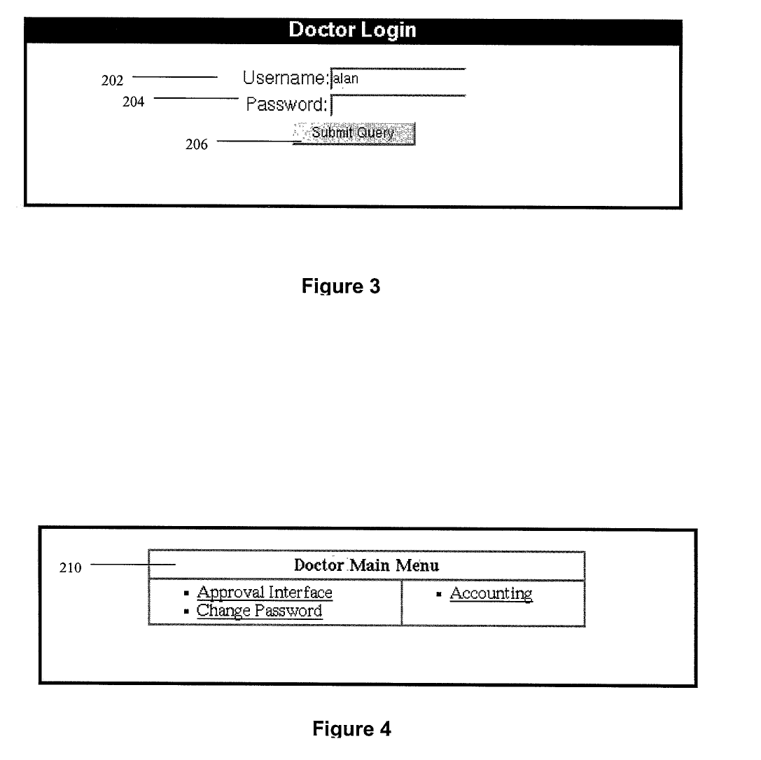

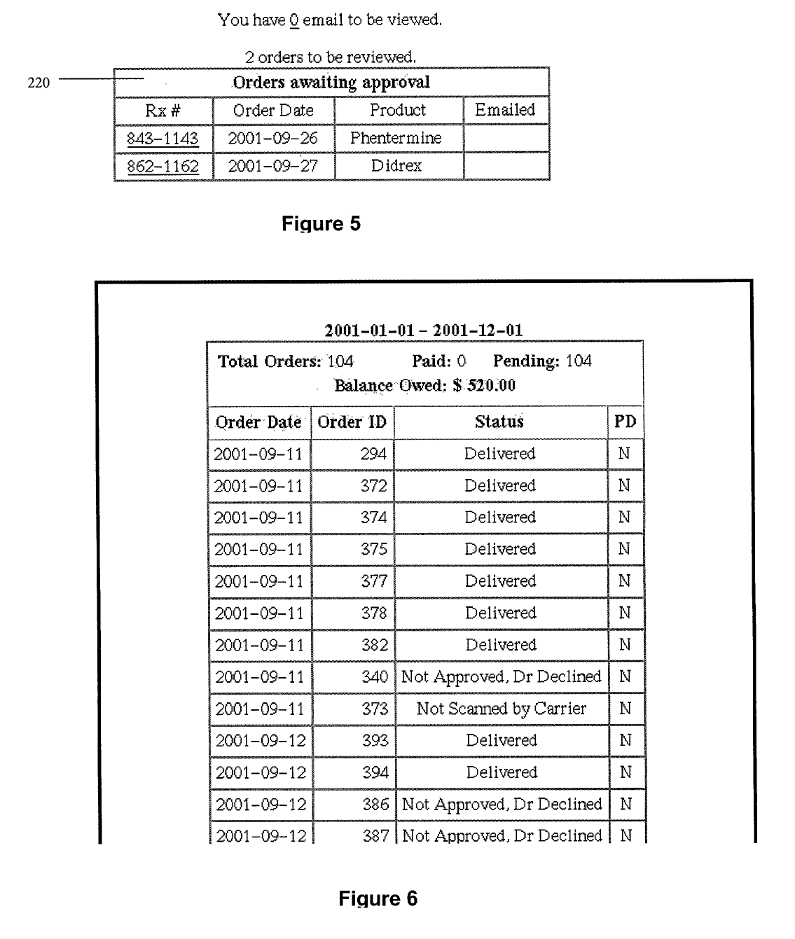

The prescription approval system of FIG. 1 operates according to the method illustrated in FIG. 2. Various screen displays are generated by the server 10 and presented on a display associated with a client 40 or doctor 30, as illustrated in FIGS. 3-7. The process begins at block 100, at which a doctor 30 or other client 40 accesses a home page associated with a pharmacy or other drug provider. Although the process preferably begins at a home page, it is possible to access an intermediate page if the address for such a page is known in advance. Likewise, the preferred embodiment contemplates the use of an Internet-based server having a web of pages written in HTML or another mark-up language. Alternatively, instead of accessing a home or other web page, the client 40 may access the server 10 via a dedicated connection, intranet, bulletin board, LAN, or other communication channel that may not require a strict analogy to a home page.

The step of accessing the home page at block 100 is performed by entering a URL, IP address, selecting a link, or using other means to allow the client computer 40 to communicate with the server 10. Once accessed, the server sends appropriate software code to the client 40 causing the client 40 to display the home page. The home page is preferably a graphical presentation that includes information related to the on-line pharmacy or other drug-dispensing business. Accordingly, it includes various listings of drugs or other offered products, contact information, frequently asked questions, pricing displays, and other information. Of course, the home page need not include any of the above, consistent with this invention, and can alternatively include additional information or organize the above categories of information on web pages other than the home page.

After accessing the home page, doctors or other professionals are asked to login at block 102. As shown in FIG. 3, the login is preferably a standard request for entry of a user name 202 and password 204. The request can be on the home page itself or can be on a separate page that is linked to the home page. In the latter case, the home page contains a button or other device to enable doctors to reach the login screen. For example, a doctor uses a pointer to select a button or other hypertext link to a page other than the home page that contains the login screen. Once at the screen containing the login routine, the doctor (or other professional) enters a user name 202 and password 204, then presses return on a keyboard or clicks a submit query button 206.

After entering a user name and password, the process proceeds to block 104 where the user name and password are verified. In order to do so, the server accesses a database stored in its associated memory 12 to determine whether the entered user name is properly assigned to the entered password. If not, an appropriate message is displayed and the process returns to block 102 to allow the doctor to edit the login information for typographical or other errors. Alternatively, the process can return the user to the home page or any other location.

After the user is verified as an authorized user, the process proceeds to block 106 at which the main menu for authorized doctors is presented. Best seen in FIG. 4, the main menu 210 includes choices that may be selected such as an approval interface, accounting interface, and administrative functions such as changing passwords. Any number of additional options may be included. Likewise, the main menu is not essential to the invention but rather could be omitted in favor of one or more alternative pages that more directly present the doctor with patient prescriptions for possible approval. A main menu format is most useful for those embodiments having a relatively large number of menu choices.

When the doctor accessing the system selects the approval interface from among the menu choices, the system proceeds to block 108, at which the doctor can request, and the system will retrieve, a pending patient order. Preferably, the initial presentation of the approval interface will indicate the number of orders requiring review, as well as pertinent information related to the proposed orders such as a prescription number, order date, requested drug or product, and whether any notices were emailed.

In the preferred embodiment, the orders awaiting approval are requested by patients themselves accessing the server 10 from any client 40. Thus, any patient or other individual accesses the server via a client in the same manner as described above with respect to the doctor. The principal difference is that patients need not login with a user name and password as doctors do because the security needs for doctor approval is more acute than for patients. Nonetheless, the system may impose a user name and password requirement for patient users as will.

In addition, prescriptions may be submitted by persons other than patients. For example, the doctor, a nurse, or other medical professional may submit the prescription in addition to reviewing it for approval. Such prescriptions may be presented using the typical patient interface, or may be submitted by the doctor within the approval interface. To do so, the doctor presses an “add” button or other appropriate indicator, then enters the product and patient information to provide the prescription for the patient.

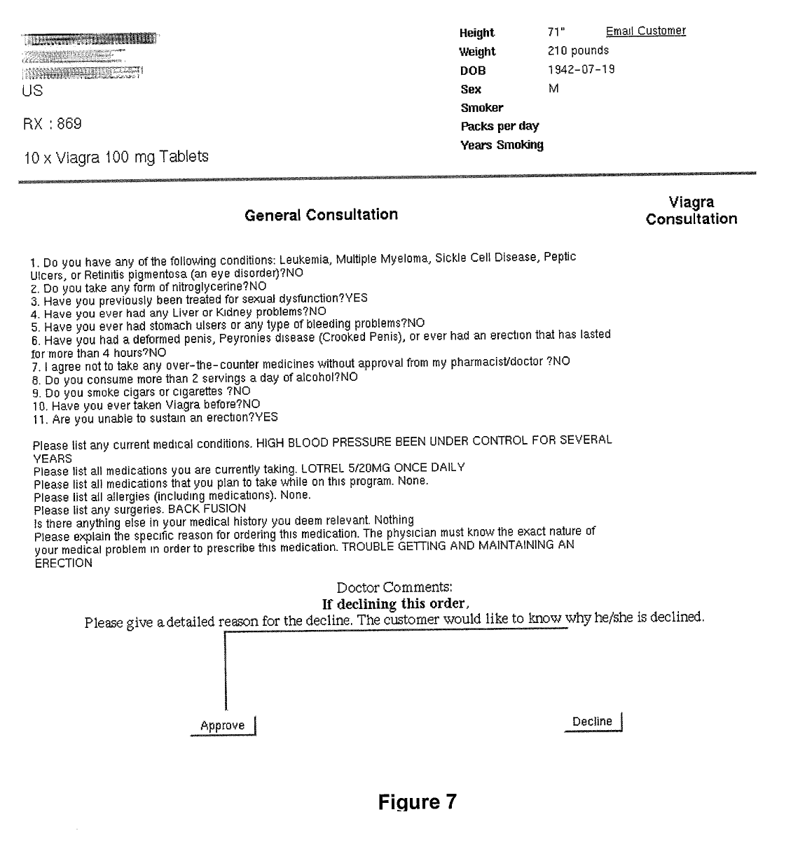

For those orders requiring a doctor prescription following a general consultation, the doctor can select a particular prescription number from the listing of orders awaiting approval. The doctor will then be presented with a general consultation form containing a patient medical history for the patient requesting the order. Best seen in FIG. 7, the general consultation includes pertinent information about the patient's history with relevant medical conditions, age, weight, current medication use, alcohol use, and other aspects. In some cases, the information presented may be a function of the prescription sought. The doctor reviews the patient history information and, as appropriate, either approves or declines the order at block 110.

While the present invention is particularly well-suited for drugs that can be dispensed without a prescription of that require only a general consultation and review of medical history in order to issue a prescription, it also works for drugs requiring a more intensive physical examination prior to issuance of a prescription. In such cases, the doctor retrieving and reviewing orders at block 108 can enter information indicating that an appropriate physical examination was performed.

If the order is declined by the doctor, the process proceeds to block 112, where the system sends the customer an appropriate notice that the order was declined. Preferably, the order is in the form of an email to the customer. In some embodiments, the notice may also include an explanation for the basis of the refusal.

If the order is approved by the doctor, the process proceeds to block 114 to process the order. The details of the order fulfilling process can vary, but preferably include sending an email to the customer indicating that the order is approved and packaging the order for shipment to the customer.

After either approving or disapproving an order, the process continues to block 116 where the doctor is given the option to review additional orders if more orders are pending and awaiting approval. If there are no more orders pending or if the doctor decides not to review more orders, the process returns to the main menu at block 106. Alternatively, if the doctor chooses to review additional orders, the process returns to block 108 to retrieve an additional order.

At the main menu, the doctor can also choose to review accounting details, as best seen in FIG. 4. After the doctor selects accounting from the main menu, the system presents an accounting display to the doctor on the client display, as illustrated in FIG. 6. The accounting display preferably includes data associated with pending orders such as an order date, identification number, status (delivered, declined, approved, not reviewed, etc.), whether the order has been paid for, and other pertinent information. Information in the accounting display can be reviewed and modified if appropriate.

While the preferred embodiment of the invention has been illustrated and described, as noted above, many changes can be made without departing from the spirit and scope of the invention. Accordingly, the scope of the invention is not limited by the disclosure of the preferred embodiment.

I claim:

1. A system for processing a customer prescription by a user via a remote client, the system comprising:
a server coupled to a network; and
a memory coupled to the server, the memory containing stored programming instructions that, when executed by the server, cause the server to:
(i) present, on a display associated with the client, information related to a prescription request;
(ii) receive user approval or disapproval of the prescription request; and
(iii) process the prescription request based upon the user approval or disapproval.

2. The system of claim 1, wherein the information presented related to the prescription request comprises medical information related to the customer.

3. The system of claim 2, wherein the information presented related to the prescription request further comprises a customer medical history.

4. The system of claim 3, wherein the stored programming instructions further cause the server to send an approval or disapproval email to the customer.

5. The system of claim 4, wherein the stored programming instructions further cause the server request from the client a user name and password, and to determine whether the user is an authorized user as a function of the user name and password.

6. The system of claim 5, wherein the user is a doctor.

7. A method for processing a customer prescription request by a user, the method comprising:
providing the customer prescription request to the user accessing a server via a remote client over a network;
providing customer medical information to the user over the network;
receiving a user approval or disapproval based upon the customer prescription request and customer medical information; and
processing the customer prescription request based upon the user approval or disapproval.

8. The method of claim 7, wherein the user is a doctor.

9. The method of claim 8, wherein the medical information presented comprises a customer medical history.

10. The method of claim 9 further comprising requesting a password from the doctor before providing the customer medical information or the customer prescription request to the doctor.

11. The method of claim 10, wherein the customer prescription request is submitted to the server by the customer accessing the server via a client over the network.

12. The method of claim 10, wherein the customer medical information is submitted to the server by the customer accessing the server via a client over the network.

13. The method of claim 10, wherein the customer prescription request is submitted by the customer via email.

14. The method of claim 10, wherein the customer medical information is submitted by the customer via email.

15. The method of claim 10, wherein the customer medical information is submitted to the server by the doctor over the network.

16. The method of claim 10, wherein processing the prescription request further comprises sending an email to the customer indicating whether the prescription request has been approved or declined.

17. The method of claim 16, wherein processing the prescription request further comprises shipping a requested prescription drug to the customer.

18. A system for processing a customer prescription request by a user via a remote client, the system comprising:
a database containing the customer prescription;
a database containing medical information associated with a customer requesting the customer prescription;
a means for presenting the customer prescription to the user over a network; and
a means for processing a user indication to approve or decline the customer prescription request.

19. The system of claim 18, further comprising a means for informing the customer whether the prescription request has been approved or declined.

20. The system of claim 19, further comprising a means to ensure that the user is a doctor authorized to approve or decline the customer prescription request.
